(19) United States
(12) Patent Application Publication
(10) Pub. No.: US 2018/0227342 A1
(43) Pub. Date: Aug. 9, 2018

(54) MEDIA STREAM MANAGEMENT SYSTEM

(71) Applicant: STREAMWIDE, Paris (FR)

(72) Inventor: Pierre Bodilis, Paris (FR)

(21) Appl. No.: 15/890,924

(22) Filed: Feb. 7, 2018

(30) Foreign Application Priority Data
Feb. 9, 2017 (FR) 17 51092

(51) Int. Cl. H04L 29/06; H04L 29/08; H04L 5/16

(52) U.S. Cl. CPC H04L 65/403; H04L 65/1069; H04L 65/608; H04L 65/80; H04L 5/16; H04L 67/28

(57) ABSTRACT

A method for transmitting media between terminals, a first terminal being identified with a plurality of session servers and second terminals each being identified with at least one of the session servers. The method comprises: upon reception by a proxy server of a single media stream from the first terminal, transmitting said media stream from the proxy server to at least one of the session servers; and/or upon reception by the proxy server of a plurality of media streams, from a plurality of session servers; transmitting, to the first terminal, a single media stream selected among the plurality of media streams received.

The invention relates to the field of communications, particularly the transmission of media streams via a network that uses an Internet protocol.

A common problem when transmitting voice and/or video media over networks that use an Internet protocol is minimizing latency. Too large of a delay between the sending of media by one user and its reception by another user affects the quality of long-distance communication and slows exchanges. In the case of a live conversation, latency prevents the parties from conversing naturally as if they were face to face. Low quality in communication during a live conversation, even if temporary, immediately creates perceptible and detrimental interruptions.

In addition, establishing and maintaining real-time and continuous synchronization between two terminals involves continuously exchanging data. Such an exchange is expensive and consumes energy and computing power, which is particularly detrimental in a context of mobile terminals. Such problems exist in point-to-point communications (involving only two parties) and become critical in multipoint communications (or “conference” mode, involving more than two parties).

In the context of a network using an internet protocol, media exchanges, in particular voice and/or video, generally occur on simultaneous bidirectional channels, also called full-duplex. Equivalently, two simultaneous unidirectional channels (“simplex”) in opposite directions can be used. In order to communicate, the terminals must be equipped with compatible hardware and software, which is complex and expensive.

The Applicant makes use of solutions enabling several parties to communicate with each other via networks using an Internet protocol, particularly more than two parties concurrently. Each terminal is connected to a central unit by means of a bidirectional but alternating channel (not simultaneous), meaning a unidirectional channel in which the direction alternates. This is also called half-duplex communication, as opposed to full-duplex.

In a session, meaning a set of terminals wanting to communicate with one another, only one user can speak at a time. A central unit arbitrates who can speak by assigning speaking authorization to each of the users in turn who request it. The terminal of the user authorized to speak then operates in transmitter mode while the other terminals participating in the session operate in receiver mode.

From the point of view of the users, the operation is reminiscent of:
the “push to talk” or “press to transmit” (PTT) of two-way radios in the field of radio communications, or more recently
the “push to talk on cellular (PoC)” in the field of mobile network communications.

Half-duplex network communications using an internet protocol work similarly for sessions with two and with more than two parties. The Applicant then allowed a user, via a single terminal, to connect and participate in multiple different sessions at the same time. The terminal connects to multiple sessions by establishing as many half-duplex channels as there are sessions. The amount of data sent and received by the terminal is multiplied by the number of sessions, which can clutter the network, and for example saturate the local area network of the terminal. The volume of data exchanged increases even further in the case of full-duplex channels.

In addition, the usual hardware and software of each terminal are not intended to operate simultaneously in multiple sessions. For example, the security software bundled with the most common browsers requests authorization to access the microphone of the terminal each time a session is joined. Multiple sessions opened through a terminal browser require significant computing power for the terminal processor. At best, this results in slowing down the other software running on the terminal, and often in latencies and dropped connections. The user experience becomes unpleasant. The Applicant has furthermore noted that the other participants in the sessions receive a poor quality media stream, for example with choppy and/or distorted sound. On the network, packet losses and jitter effects are observed. In testing by the Applicant, such defects appear when a terminal participates in more than two simultaneous sessions, which is not satisfactory.

The invention improves the situation.

The Applicant proposes a method for transmitting media between a first terminal and at least one second terminal among a plurality of second terminals, the first terminal being identified with a plurality of session servers while each of the second terminals is identified with at least one session server among said plurality of session servers. Each of the session servers establishes communication channels from one terminal to at least one other terminal among the terminals identified with said session server. The method comprises:
upon reception by a proxy server of a single media stream from the first terminal:
   transmitting said media stream from the proxy server to at least one of the session servers selected among said plurality of session servers;
      and/or
upon reception by the proxy server of a plurality of media streams, each originating from a second terminal, from a plurality of session servers,
   transmitting, from the proxy server to the first terminal, a single media stream selected among the plurality of received media streams.

Such a method makes it possible to implement a single media stream, alternating between transmission from the first terminal and reception at the first terminal. Thus, regardless of the number of sessions in which the user of the first terminal is participating, the media stream can be processed by the usual computer means of the first terminal, without needing to adapt the hardware or software. In transmission, the media stream is transmitted via a single channel to the proxy server, regardless of the final destination or final destinations. The proxy server then transmits the media stream to each of the session servers.

The proxy server may be remote from the first terminal, for example located in a part of the network arranged to support several media streams concurrently, while the first terminal may be located in a part of the network with more limited capabilities. For the first terminal, participation in a plurality of sessions is equivalent to participation in a single session. The security software only requests access to the microphone once, regardless of the number of sessions in which the user has speaking authorization. For example, the Applicant has not observed any quality deficiencies when the first terminal is connected to fifteen sessions concurrently.

In another aspect, the Applicant proposes a system for transmitting media between a first terminal and at least one second terminal among a plurality of second terminals, the first terminal being identified with a plurality of session servers while each of the second terminals is identified with at least one of said plurality of session servers. Each of the session servers establishes communication channels from a terminal to at least one other terminal among the terminals identified with said session server. The system comprises a proxy server arranged to:
upon reception of a single media stream, from the first terminal,
   transmit said media stream to at least one of the session servers selected among said plurality of session servers;
      and
upon reception of a plurality of media streams, each originating from a second terminal, from a plurality of session servers,
   transmit to the first terminal a single media stream selected among the plurality of received media streams.

In another aspect, the Applicant proposes a computer program comprising instructions for implementing the above method, when it is implemented by at least one processor of a proxy server of a system as defined herein.

The following features may optionally be implemented. They may be implemented independently of each other or in combination with each other:
The method comprises:
   upon reception by a proxy server of a single media stream associated with addressing data, from the first terminal,
      selection by the proxy server of at least one of the session servers, based on the addressing data, and
      transmission of said media stream from the proxy server to each of the selected session servers.

This allows transmitting a single stream from the first terminal, while enabling the user of the first terminal to speak in one or more sessions at a time according to his choices. The workload of the first terminal remains substantially equivalent to what is required to speak in a single session, and the amount of data that must travel over the local area network of the first terminal is also substantially equivalent to what is used to speak in a single session.
The method comprises:
   upon reception by the proxy server of a plurality of media streams each originating from a second terminal, from a plurality of session servers,
      transmitting from the proxy server to the first terminal a single received media stream selected among the plurality of media streams, associated with identification data able to identify the source of said selected media stream among the session servers and/or among the second terminals.

This allows the user of the first terminal to remain connected to multiple sessions at a time while receiving a single stream at the first terminal that is selected according to the user's choices. The workload of the first terminal remains substantially equivalent to what is required to listen to a single session, and the amount of data that must travel the local area network of the first terminal is also substantially equivalent to what is used to listen to a single session. Using the source identification data, the first terminal can be set up to inform the user of the identity of the media stream source in parallel with the retransmission of the media.
The method comprises:
   upon reception by the proxy server of a speaking authorization request, from the first terminal,
      transmitting said request, from the proxy server to at least one of the session servers;
         and/or
upon reception by the proxy server of a speaking authorization, from at least one session server:
   transmitting said received authorization, from the proxy server to the first terminal.

This makes it possible to use the proxy server as an intermediary for managing speaking authorizations. The resources of the first terminal can be used to transmit or receive a media stream regardless of the number of sessions.
The method comprises:
   waiting to receive at least one speaking authorization from the proxy server, for the first terminal, and
   upon receiving said authorization, transmitting the media stream from the first terminal to the proxy server.

This reduces the risk of several separate and concomitant media streams being sent to the same session, which affects the quality of the communication or involves downstream filtering of the received media streams.
The authorization is associated with identification data able to identify the source of the authorization among the session servers, said transmitted media stream being associated with addressing data established on the basis of the source of the at least one authorization received.

This enables the first terminal, during transmission of the stream, to indicate to the user of the first terminal a list of sessions and/or second terminals actually listening to the first stream.
The communication channels are half-duplex.

This makes it possible to limit the resources required for the one-way transmission of streams at each moment, and to avoid monopolizing unneeded resources.
The first terminal and the proxy server are far apart from one another and are able to communicate with each other via the Internet. Management of the proxy server may be ensured by a different entity than the user of the first terminal. Most existing terminals can be made compatible in order to constitute a first terminal, by means of minor software adaptations. The performance of the proxy server can be adapted as needed, including dynamically.

Other features, details, and advantages of the invention will be apparent from reading the following detailed description, and from an analysis of the appended drawings, in which:

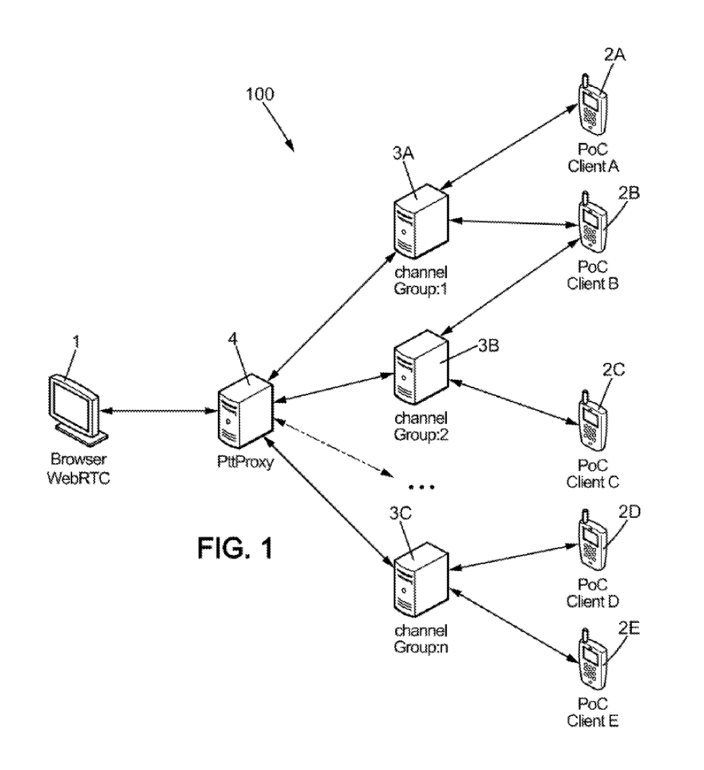

FIG. 1 schematically shows the interconnections of elements that are part of a system according to the invention, and

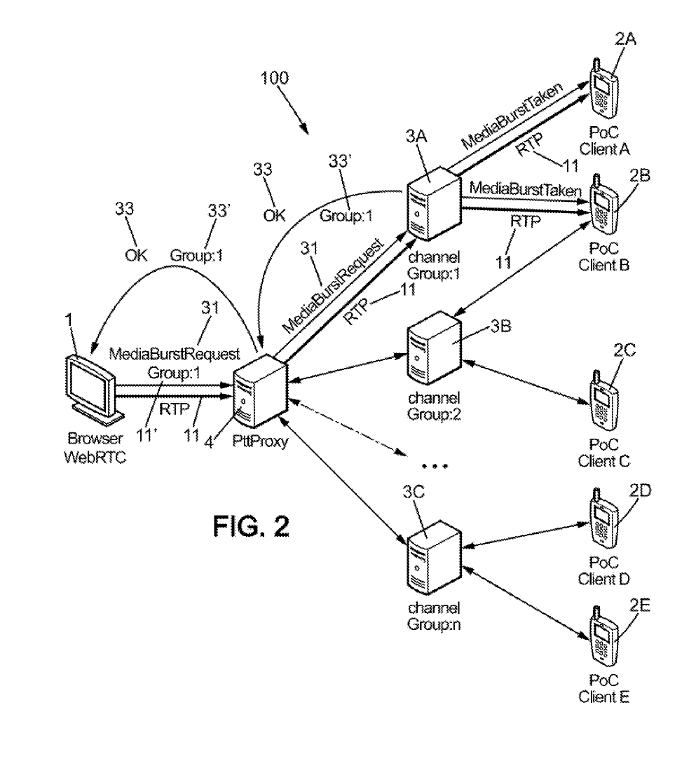

FIGS. 2 to 6, equivalent to FIG. 1, each represent a situation for application of a method according to the invention.

The drawings and the following description contain, for the most part, elements of a specific nature. They therefore not only serve to provide a better understanding of the invention, but where appropriate also contribute to its definition.

From a technical point of view, the constraints and characteristics of radiocommunication and telephony systems are generally not transposable to communications by networks that function using an Internet Protocol (IP). Therefore, references to “walkie-talkie” mode are used merely to illustrate a communication mode of alternating turns from the user's point of view.

In the following, we distinguish the nature of the data exchanged by using the term “media” to designate data relating to media content to be transmitted, and terms such as “identification data” or “addressing data” to designate data other than those relating to the media content itself. The volumes/sizes of data relating to media content to be transmitted are generally greater than those of the other data.

We now refer to FIG. 1 which illustrates an embodiment of the invention. A system 100 of media transmission is represented. The system 100 comprises:
a first communication terminal 1;
second communication terminals 2A, 2B, 2C, 2D, 2E;
session servers 3A, 3B, 3C; and
a proxy server 4.

In the following, reference 2 and reference 3 are respectively used to designate the second terminals 2A, 2B, 2C, 2D, 2E for the former and the session servers 3A, 3B, 3C for the latter.

In the example described here, the first terminal 1 is connected to each of the session servers 3 via a single proxy server 4. Each of the second terminals 2 is directly connected to one or more session servers 3. “Directly” is understood here to mean without a server similar to the proxy server 4 being arranged between the second terminal 2 and the session server 3. In the example, there is only one first terminal 1. Alternatively, the system may comprise a plurality of first terminals 1 connected by a common or respective proxy server 4. The terms “first terminal” and “second terminal” are used to distinguish terminals connected to the session servers 3 via a proxy server 4 and those that are not. Otherwise the first terminals 1 and second terminals 2 can be similar.

Each of the first and second terminals 1, 2 may comprise any electronic device comprising at least one processor and communication means, and able to connect to a network that functions using an Internet protocol, for example a computer, tablet, or smartphone. Each communication terminal 1, 2 comprises an operating system and programs, components, modules, applications in the form of software executed by the processors, which can be stored in non-volatile memory.

Here, each terminal 1, 2 is available to a user. Each terminal can be considered as equivalent to a user, each of the users being assumed to be at a distance from the others. Each session server 3 is considered equivalent to a session, or a group of users wishing to exchange media streams between them.

Media stream here refers in particular to audio data, and even more specifically to voice data, such that the system 100 can be used by users to hold voice conversations. Alternatively, the media stream may comprise video or text data, or may be a multimedia stream and comprise a combination of at least two types of data among video, audio, and text. In the following, the term “speaking” is used in general to designate the action of monopolizing the role of media stream transmission among a set of terminals 1, 2 of a session, regardless of the nature of the media.

In FIG. 1, the session servers 3 and the proxy server 4 are represented as distinct from each other. Such a functional distinction of the servers 3, 4 facilitates understanding. The servers 3, 4 may comprise separate physical devices, for example at a distance from each other and interconnected via a network using an Internet protocol. Alternatively, at least some of the session servers 3 and proxy server 4 may be at least partly shared. In particular, the servers 3, 4 may share one or more processors. Each server 3, 4 may comprise an operating system and programs, components, modules, applications in the form of software executed by the processors, which can be stored in non-volatile memory. For example, the session servers 3 may be grouped and/or managed by a service provider and be connected to the Internet. The proxy server(s) 4 may for example be grouped and/or managed by a client company of the service provider and be connected to an intranet of the client company, which is itself connected to the Internet. The proxy server 4 may take the form of an intermediate application associated with a browser of the first terminal.

Each session may be of short duration and considered temporary, or of long duration and considered permanent. Allocation of resources of the devices forming a session server 3 can therefore be dynamic.

Here, each second terminal 2A, 2C, 2D, 2E is connected to a single server 3, with the exception of terminal 2B which is connected to both session server 3A and session server 3B.

In FIG. 1, the devices are interconnected by two-way arrows. This indicates that one or more data connections allow transporting data between the devices in order to establish, control, and terminate a session. The data here do not include the media stream. The exchange of data and media stream transmissions can be implemented using known protocols. For example, the exchange of data is implemented using the Session Initiation Protocol (SIP). The transmission of streams is implemented using the Real-time Transport Protocol (RTP), here supplemented by the Real-time Transport Control Protocol (RTCP).

In a first step, the user of the first terminal 1 connects the first terminal 1 to the proxy server 4. For example, after having authorized access to the microphone, the browser of the first terminal 1 establishes a single outgoing call with the proxy server 4. Such a call can be implemented by means of known techniques, for example Web Real Time Communication technologies, better known by the acronym WebRTC. One connection by TLS protocol is established from the first terminal 1. Next, the first terminal 1 sends or receives a single media stream at a time. A “SIP over TLS” connection is implemented here. The media uses the WebRTC stack built into the browser of the first terminal 1 and which includes RTP transmission and receiving.

The media stream travels a first half-duplex channel portion between the first terminal 1 and the proxy server 4.

The proxy server 4 transmits the single media stream received from the first terminal 1 to one of the session servers 3. Similarly, the proxy server 4 transmits to the first terminal 1 a single media stream received from a session server 3, among the one media stream received from a session server 3 or among the plurality of media streams received from the respective session servers 3.

The media stream may travel by a second half-duplex channel portion between the proxy server 4 and each of the session servers 3 concerned. The media stream may travel by a third half-duplex channel portion between each session server 3 and the corresponding second terminals 2.

FIG. 2 represents a scenario in which the user of the first terminal 1 wishes to speak in the group corresponding to session server 3A. In other words, the user wishes to send media, for example his voice, only to the users of the second terminals 2A and 2B associated with session server 3A. To do this, the first terminal 1 transmits data in the form of a request 31, or a speaking authorization message (denoted “MediaBurstRequest”), to the session server 3A, here via the proxy server 4. Such a request can be transmitted for example by SIP.

The first terminal 1 transmits a media stream 11 to the proxy server 4, here by RTP and on a half-duplex channel portion. Upon reception of the data stream 11 from the first terminal 1 by the proxy server 4, the proxy server 4 transmits the data stream 11 to at least one of the session servers 3.

In the example described here, the first terminal 1 further transmits addressing data 11′ to the proxy server 4, for example in the form of a set of identifiers (“SessionID”) of the recipient sessions. Such addressing data 11′ may be transmitted, for example, by SIP. The addressing data 11′ are associated with the media stream 11: the addressing data indicate the recipient(s) of the media stream 11.

Upon reception of the media stream 11 associated with the addressing data 11′, the proxy server 4 identifies at least one of the session servers 3, based on the addressing data 11′. Next, the proxy server 4 transmits the media stream 11 to each of the identified session servers 3, here only session server 3A.

In variants, in the absence of addressing data 11′, the proxy server 4 may be arranged to identify default session servers 3 among those with which terminal 1 is identified. For example, when a single session is active for the first terminal 1, in other words when the proxy server 4 is connected to a single session server 3, then the proxy server 4 can identify by default the only possible session server among those with which terminal 1 is identified. When the first terminal 1 is identified with multiple sessions, the proxy server 4 can identify a single session server 3 to which to transmit the media stream 11 based on pre-established priority rules, for example a scheduling of session servers 3 relative to one another. When the first terminal 1 is identified with multiple sessions, the proxy server 4 can also identify, by default, all session servers 3 accessible as recipients of the media stream 11. The proxy server 4 can be configured to reject the request for transmission of a stream from the first terminal 1 when said stream is intended for a session server with which the first terminal 1 is not identified, and to send an error message to the first terminal 1.

Upon receiving the request 31 and if no one has speaking authorization, meaning transmission is not yet monopolized by another terminal 2A, 2B, the session server 3A grants speaking authorization to the first terminal 1. The session server 3A sends, here in SIP:
in response to the first terminal 1, via the proxy server 4, data in the form of a speaking authorization 33 (“OK”), and
to the other terminals 2A, 2B of the session, data in the form of a message indicating that speaking authorization is assigned (“MediaBurstTaken”).

Upon receiving a speaking authorization request 31 from the first terminal 1, the proxy server 4 sends the request 31 to at least one of the session servers 3. Upon receiving a speaking authorization 33 from at least one session server 3, the proxy server 4 sends the received authorization 33 to the first terminal 1.

Upon receiving the media stream 11, the session server 3A transmits the media stream 11 to each of the other terminals of the session, here the second terminals 2A and 2B. Transmission of the media stream 11 is carried out here by RTP and on half-duplex channel portions.

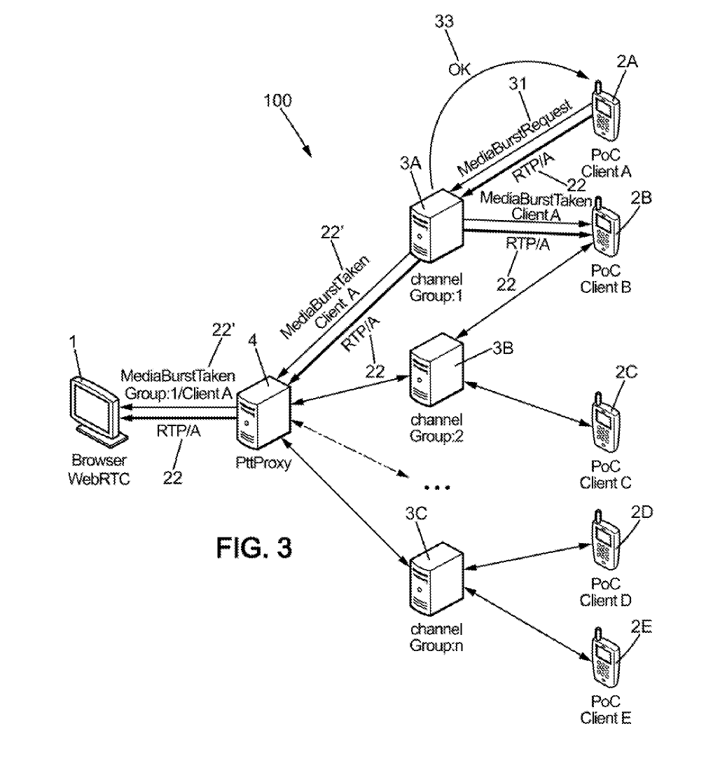

FIG. 3 represents a scenario in which the user of second terminal 2A wishes to have speaking authorization in the group corresponding to session server 3A, meaning he or she wishes to address the users of the first terminal 1 and second terminal 2B. Second terminal 2A transmits a speaking authorization request 31 to session server 3A, here in SIP.

Second terminal 2A transmits a media stream 22 to session server 3A, here by RTP and on a half-duplex channel portion. When session server 3A receives the media stream 22 from second terminal 2A, session server 3A in turn transmits the media stream 22 to second terminal 2B and to the proxy server 4, here by RTP and on a respective half-duplex channel portion.

Upon receiving the media stream 22 originating from second terminal 2A from session server 3A, the proxy server 4 transmits the received media stream 22 to the first terminal 1.

In the example described here, the second terminal 2A further transmits identification data 22′ to session server 3A, for example in the form of an identifier of second terminal 2A. Alternatively, the identifier of second terminal 2A is established by session server 3A without it being necessary to transmit it from second terminal 2A. Session server 3A transmits the identification data 22′ comprising the identifier of second terminal 2A and adding to it an identifier of the session. Such identification data 22′ may be transmitted, for example, by SIP. The identification data 22′ is associated with the media stream 22: the identification data 22′ indicate the source of the media stream 22.

When received, the proxy server 4 transmits to the first terminal 1 the received media stream 22 and the associated identification data 22′. The identification data 22′ are able to identify the source of the media stream 22 among the session servers 3 and among the second terminals 2. Alternatively, the identification data 22′ comprise only data able to identify the source of the media stream 22 among the session servers 3, or only data able to identify the source of the media stream 22 among the second terminals 2. Alternatively, the identification data 22′ are absent.

In the example described here, the transmission of identification data 22′, or signaling, is performed by superimposed SIP and TLS protocols so that TCP security is provided for the communication. In a prior step, the first terminal 1 is identified with the proxy server 4 during an identification request with a session and a session server 3, by means of an identifier and a temporary password. The temporary password is retrieved by the user of the first terminal 1 from a database, here by XML-RPC, to improve the interoperability of terminals and servers. The session servers 3 identify the first terminal 1 by accessing the temporary password in said database. The first terminal 1 remains identified with the session terminal 3 for the duration of the session, or as long as the connection is not interrupted.

In the example described here, each of the session servers 3 establishes a half-duplex communication channel with each of the terminals identified with said session server 3. The proxy server 4 also establishes a half-duplex communication channel with the first terminal 1. The communication channels are negotiated by SDP when the communication is established. The communication channels are static. In other words, the half-duplex communication channels used are constant during a session between the first terminal 1 and a session server 3, and during a communication between the first terminal 1 and a proxy server 4.

Alternatively, each of the session servers 3 dynamically establishes a half-duplex communication channel from a terminal to at least one other terminal among the terminals identified with said session server 3. In other words, the half-duplex communication channels used change over time, in particular on the basis of the speaking authorizations.

In the two previous scenarios, the media stream 11, 22 is transmitted independently of the sending of the speaking authorization request 31. Alternatively, the source (the first terminal 1 in the case of FIG. 2 or second terminal 2A in the case of FIG. 3) waits to receive the speaking authorization 33. Upon receiving the authorization 33, the media stream 11, 22 is transmitted. The authorization 33 may be associated with identification data 33′ able to identify the source of the authorization 33 among the session servers 3A, 3B, 3C. Thus, in the cases where the proxy server 4 transmits multiple authorization requests 31 to multiple session servers 3A, 3B, 3C, the proxy server 4 in return can identify the session servers 3A, 3B, 3C for which authorization 33 is given. The user of the first terminal 1 can speak, meaning transmit media simultaneously to each of the groups of users for which an authorization 33 is received. For example, the media stream 22 transmitted from the first terminal 1 is associated with addressing data 11′ selected according to the source of each of the at least one authorization 33 previously received.

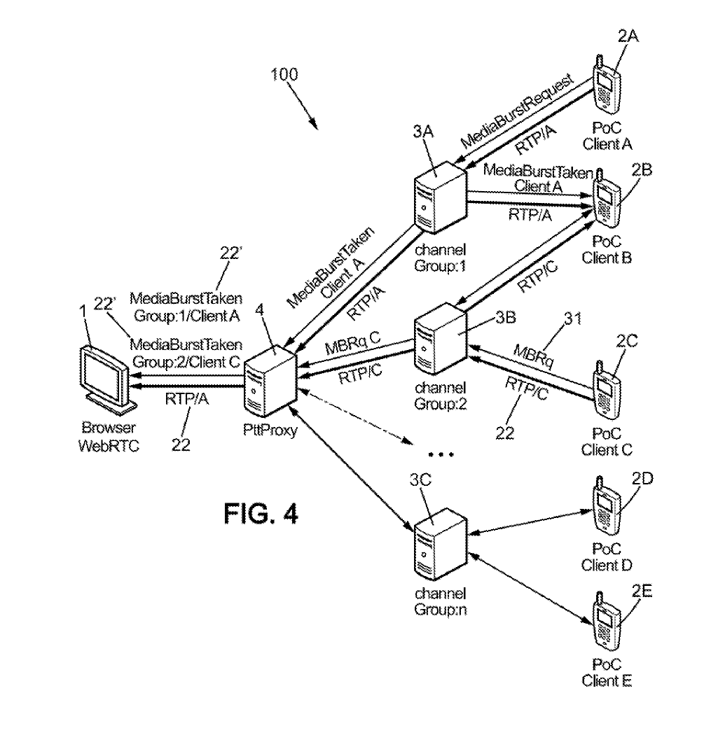

We now refer to FIG. 4. The scenario is similar to that of FIG. 3. In addition, the user of second terminal 2C also issues a speaking authorization request 31 and obtains an authorization 33 in return. Second terminal 2A thus sends a media stream 22 to the users of the first group corresponding to session server 3A, while second terminal 2C sends a media stream 22 to the users of the second group corresponding to session server 3B. The proxy server 4 receives the two media streams 22.

Each of the media streams 22 originating from a second terminal 2A, respectively 2C, received by the proxy server 4 from at least one session server 3A, respectively 3B, is associated with identification data 22 ‘. The identification data 22’ are able to identify the source of the media stream 22 among session servers 3A, 3B and/or among second terminals 2A, 2C. In the example described here, the identification data 22′ are able to identify both the transmitting session server 3 and the transmitting second terminal 2.

In the example described here, in the case of receiving at least two media streams 22 originating from at least one second terminal 2A, 2C, from at least two session servers 3A, 3B, the proxy server 4 is arranged to select a single media stream 22 among the received media streams 22. Transmission from the proxy server 4 to the first terminal 1 is applied only to the selected media stream 22. In other words, the proxy server 4 filters the received media streams 22, for example in order to transmit only one. Thus, depending on the parameters settings of the proxy server 4, the first terminal 1 receives only one media stream 22 regardless of the number of media streams 22 received by the proxy server 4.

Selection by the proxy server 4 of the media stream 22 among several streams may be done by applying a set of priority rules. For example, the order of priority of session servers 3 may default to the chronological order of the connection of the first user to each of the sessions. An administrator can set the priority rules, said rules being for example stored in a database accessible to the proxy server 4. The user may also establish an order of priority if so desired, for example via the first terminal 1. The user may also make an on-the-fly selection of which media stream 22 to receive among those available. The proxy server 4 may be arranged to transmit a list of active sessions to the first terminal 1, meaning those for which transmission of a media stream is in progress. The session list may further include other information such as an identifier of the second terminal 2 transmitting in each session. The priority rules may also be defined according to a temporary marker of the speaking authorization in each media stream 22, for example to give priority to selecting the media stream 22 corresponding to the oldest speaking authorization.

In the example of FIG. 4, in contrast to the first terminal 1, second terminal 2B receives the two media streams 22, one via session server 3A and the other via session server 3B. Second terminal 2B is arranged to select which of the two streams 22 to retransmit to the user (via a screen and/or speaker for example). The selection may be defined by a default setting and/or made by the user who chooses which stream to retransmit among the two media streams 22.

In a variant of the scenario of FIG. 4, second terminal 2B is taking the speaking authorization from second terminals 2A and 2C, simultaneously via session server 3A and session server 3B. In such a case, the proxy server 4 is arranged to select, from the two media streams 22 of identical content, which one to transmit to the first terminal 1.

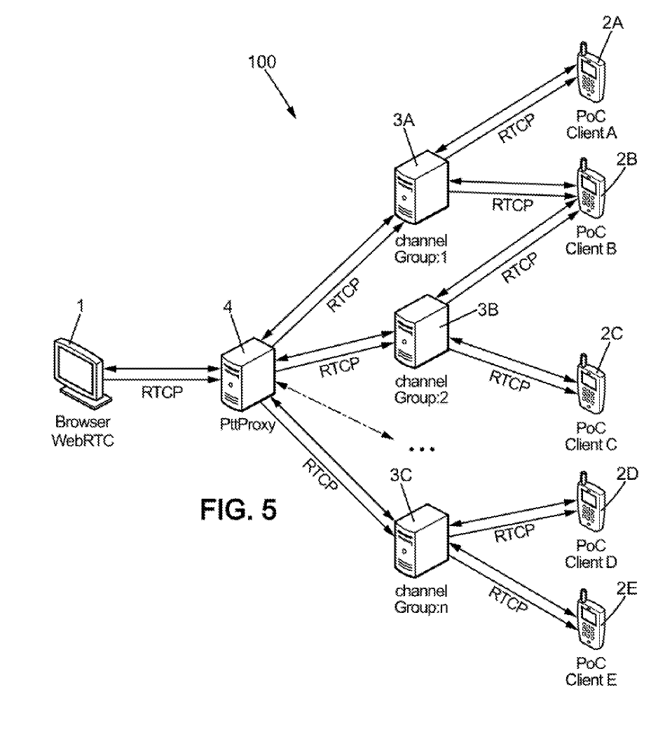

FIG. 5 represents the transmission of control data by the first terminal 1. The control data here are in the form of the Real-time Transport Control Protocol (RTCP), corresponding to the RTP protocol described above. Such data allows each participant in a session to obtain information about session participants and the quality of service.

The control data from the first terminal 1 are transmitted to each of the second terminals 2 participating in at least one session in common with the first terminal 1. Such transmission is provided via the proxy server 4 and each of the corresponding session servers 3.

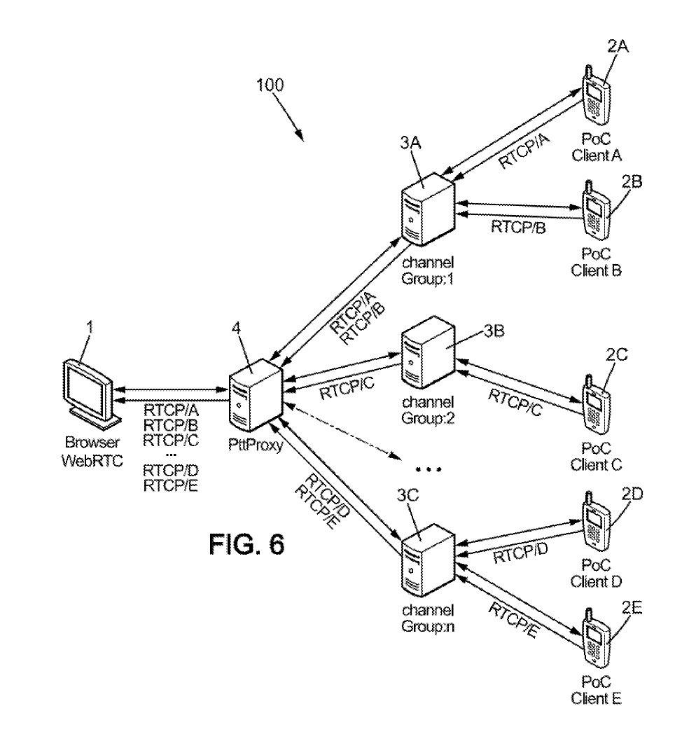

FIG. 6 represents the transmission of control data by each of the second terminals 2, here again using RTCP. Each set of control data from each of the second terminals 2 is transmitted to the first terminal 1. Such transmission is provided via each of the corresponding session servers 3 and the proxy server 4.

Each of the first terminal 1 and second terminals 2 are further arranged to transmit a “MediaBurstRelease” type of SIP message to release speaking authorization at the end of the transmission of the media stream 22. Upon receiving such a message, each of the session servers 3 transmits a “MediaBurstIdle” type of message to each of the other participants of the session, indicating that someone else can speak. In situations where no speaking authorization has been assigned, no media stream 22 is transmitted between the session participants via the corresponding session server 3. In this case, only control data (RTCP) are exchanged, as represented in FIGS. 5 and 6. The proxy server 4 and/or the session servers 3 may be arranged to detect disconnections not previously indicated and/or unindicated speaking authorization releases, and in such cases to issue a message indicating that no one holds the speaking authorization, without waiting to receive a message from the corresponding terminals 1, 2.

In some embodiments, when a user of the first terminal 1 wishes to join a session, an SIP message is sent from the first terminal 1 to the corresponding session server 3, and via the proxy server 4. Such a message may, for example, be sent via a browser of the first terminal 1, for example after requesting access to the microphone of the first terminal 1. Once the connection is established, a “JoinSession” type SIP message is sent to the proxy server 4. The SIP message may be accompanied by a session identifier and user identification and/or authentication data. The proxy server 4 authenticates the user and then establishes an outgoing call to the session server 3 corresponding to the session to be joined.

When the connection to the session is established, the proxy server 4 acts as a relay between the first terminal 1 and each of the session servers 3. The proxy server 4 transmits all the messages between the user and the session. During the transmission, the proxy server 4 can modify the message, for example by adding data such as the addressing data 11′ and/or the identification data 22′. Such data may be in the form of headers such as “SessionId” or “UserID”. In the example described here, the user identifier comprises a public identifier for the user, for example his or her telephone number, or MSISDN (“Mobile Station-Integrated Services Digital Network”). The data may be transmitted by RTP. The messages from the first terminal 1 are transmitted to the session corresponding to the identifier contained in such a field. The messages from a session server 3 are transmitted to the first terminal 1, with the session identifier added.

Alternatively, other messages may be exchanged. For example:
A “QuitSession” type of SIP message associated with one or more session identifiers is sent by the first terminal 1 to the proxy server 4 when the user wishes to leave the corresponding session or sessions. In these cases, the proxy server 4 transmits a “Bye” type of message to each of the session servers 3 concerned. Each of the session servers 3 sends a “ParticipantLeft” type of message in response, to each of the other terminals 2 of the session;
A “HungUpBySession” type of SIP message is sent by the proxy server 4 to the first terminal 1 when a session hangs up on the proxy server 4;
When a “Bye” type of SIP message is sent from the first terminal 1 to the proxy server 4, or a disconnection is detected between the two, the proxy server 4 transmits a “Bye” type of SIP message to each of the session servers 3.

In some embodiments, the first terminal 1 and the proxy server 4 are far apart from one another. The first terminal 1 and the proxy server 4 communicate via the Internet. For example, the proxy server 4 may belong to a service provider, while the first terminal 1 belongs to a customer of the service provider. In such a configuration, the proxy server 4 can be likened to a service access point for the user of the first terminal 1, a “front end”. The proxy server 4 and the session servers 3 may for example communicate via a private network managed by the service provider.

Thus, the service provider can adapt the private network to requirements, in particular based on the volume of data and streams to be exchanged. The public network (here the Internet) and the local private network of the user of the first terminal 1 must transport a volume of data and of streams that varies little with the number of simultaneous connections of the first terminal 1. The risk of saturating the local area network is reduced. In practice, connections to fifteen simultaneous sessions do not result in problems with communication quality.

Usually, the term “proxy”, or proxy server, refers to a device that serves as a relay between two other devices. Here, the proxy server 4 acts as a relay between the first terminal 1 and the session servers 3. The proxy server 4 could therefore be called a “proxy”. However, in the context of voice over internet protocol (VoIP) transmission, it is customary to designate as “proxy” the device that merely relays data (usually SIP) for establishing, controlling, and ending a session, while the media stream (usually RTP) does not pass through the proxy. It should be noted that in the present context, the proxy server 4 relays the media stream and possibly other data.

Unless incompatible, the various aspects and features described above may be implemented together, separately, or as substitutions for one another. According to one aspect, the invention can be viewed as a method implemented by computer means. According to another aspect, the invention can be viewed as a system capable of implementing the method.

In the preceding examples, each of the communication channels used is half-duplex. This makes it possible to limit the volume of data exchanged at each moment and therefore to save bandwidth in each part of the network. Combined with the proxy server, this reduces the risk of poor communication quality. Alternatively, at least some of the communication channels may be full-duplex.

The invention may take the form of a computer program comprising instructions for implementing a method or part of the methods described above when it is implemented by at least one processor of a terminal 1, 2 or of a server 3, 4.

The invention is not limited to the examples of software, methods, and systems described above only as examples, but encompasses all variants conceivable to those skilled in the art within the scope of the following claims.

1. A method for transmitting media between a first terminal and at least one second terminal among a plurality of second terminals, said first terminal being identified with a plurality of session servers while each of said second terminals is identified with at least one session server among said plurality of session servers,
each of said session servers establishing communication channels from one of said first and second terminals to at least one other of said first and second terminals among said first and second terminals identified with said session server,
the method comprising:
upon reception by a proxy server of a single media stream from said first terminal,
transmitting said media stream from said proxy server to at least one of session servers selected among said plurality of session servers;
and/or
upon reception by said proxy server of a plurality of media streams, each originating from a said second terminal, from a plurality of said session servers,
transmitting, from said proxy server to said first terminal, a single media stream selected among said plurality of media streams received.

2. The method according to claim 1, comprising:
upon reception by a said proxy server of a single media stream associated with addressing data, from said first terminal,
selection by said proxy server of at least one of said session servers, based on said addressing data; and
transmission of said media stream from said proxy server to each of the selected session servers.

3. The method according to claim 1, further comprising:
upon reception by said proxy server of a plurality of media streams each originating from a said second terminal, from said plurality of session servers,
transmitting from said proxy server to said first terminal a single received media stream selected among said plurality of media streams, associated with identification data able to identify a source of said selected media stream among said session servers and/or among said second terminals (2A, 2B, 2C, 2D, 2E).

4. The method according to claim 1, further comprising:
upon reception by said proxy server of a speaking authorization request, from said first terminal,
transmitting said request, from said proxy server to at least one of said session servers;
and/or
upon reception by said proxy server of a speaking authorization, from at least one said session server,
transmitting the received authorization, from said proxy server to said first terminal.

5. The method according to claim 1, further comprising:
waiting to receive at least one speaking authorization from said proxy server, for said first terminal, and
upon receiving the authorization, transmitting a media stream from the said first terminal to said proxy server.

6. The method according to claim 5, wherein said authorization is associated with identification data able to identify a source of said authorization among said session servers, said transmitted media stream being associated with addressing data established on the basis of a source of the at least one authorization received.

7. The method according to claim 1, wherein said communication channels are half-duplex.

8. A system for transmitting media between a first terminal and at least one second terminal among a plurality of second terminals, said first terminal being identified with a plurality of session servers while each of said second terminals is identified with at least one session server among said plurality of session servers,
each of said session servers establishing communication channels from one of said first and second terminals to at least one other of said first and second terminals among said first and second terminals identified with said session server,
the system comprising a proxy server arranged to:
upon reception of a single media stream, from said first terminal,
transmitting said media stream to at least one of said session servers selected among said plurality of session servers; and
upon reception of a plurality of media streams, each originating from a said second terminal, from a plurality of said session servers,
transmitting to said first terminal a single media stream selected among said plurality of received media streams.

9. The system according to claim 8, wherein said first terminal and said proxy server are far apart from one another and are able to communicate with each other via the Internet.

10. A computer program comprising instructions for implementing the method according to claim 1, when it is implemented by at least one processor of a proxy server of a system for transmitting media between a first terminal and at least one second terminal among a plurality of second terminals, said first terminal being identified with a plurality of session servers while each of said second terminals is identified with at least one session server among said plurality of session servers,
each of said session servers establishing communication channels from one of said first and second terminals to at least one other of said first and second terminals among said first and second terminals identified with said session server,
the system comprising a proxy server arranged to:
upon reception of a single media stream, from said first terminal,
transmitting said media stream to at least one of said session servers selected among said plurality of session servers;
and
upon reception of a plurality of media streams, each originating from a said second terminal, from a plurality of said session servers,
transmitting to said first terminal a single media stream selected among said plurality of received media streams.
